(19) United States
(12) Patent Application Publication
(10) Pub. No.: US 2011/0031213 A1
(43) Pub. Date: Feb. 10, 2011

(54) Method for Marking Valuable Articles

(76) Inventor: Yuri Konstantinovich Nizienko, Troitsk (RU)

Correspondence Address: MILLER, MATTHIAS & HULL, ONE NORTH FRANKLIN STREET, SUITE 2350, CHICAGO, IL, 60606, US

(21) Appl. No.: 12/671,006

(22) PCT Filed: Jul. 27, 2007
(86) PCT No.: PCT/RU2007/000407

§ 371 Date: Jun. 18, 2010

(51) Int. Cl. B44C 1/22

(52) U.S. Cl. 216/45

(57) ABSTRACT

The disclosure relates to methods of marking valuable items, mainly precious stones and in particular, cut diamonds, and can be used for their identification. To implement the marking procedure, the identification surface of the product is first polished. A marking image, optically visible in reflected light is formed on the polished surface by modifying the identification area of said surface by means of a guided ion beam with a given ion energy. In the modification process, the composition of the surface layer is modified with the possibility of changing the optical properties of modified sites in relation to the optical properties of untreated sites of the identification surface. The modification of the identification surface is carried out by a pulse ion beam through a stencil mask, resulting in implantation of modifier ions into the crystal lattice of the marking area of the surface layer without damaging the covalent bonds between the atoms of the lattice and, accordingly, without damage to the original topography of this layer. Said changes in the optical properties of the marking area are provided through the use as a modifier of such material, the ions of which alter the complex refractive index of the base material upon implantation into its crystal lattice as doping additives.

### FIELD OF TECHNOLOGY

The invention relates to methods of marking valuable items, mainly precious stones and in particular, cut diamonds, and can be used for their identification.

### PRIOR ART

From the prior art, a method is known for creation and visualization of optically invisible marks, according to which the surface of the object is first polished. On the polished surface, an optically invisible marking image is formed by modifying at least one area of the surface. As a result of surface modification, the surface energy of the modified sites changes. This marking image is then visualized by means of establishing a meta-stable environment in the vicinity of the aforementioned surface of the object. By the means of said environment, the marking image is produced in the form of distinguished structures formed by stable phase particles of the meta-stable environment at the sites of the object surface having different surface energy. (WO 02/089041, C1. EP 1391841).

The disadvantages of this known method include image quality dependence on contamination of the viewed surface.

It should also be noted that such marking with condensate is useful when the size of modified sites is larger than the typical size of condensate droplets, if the size of strokes or dots that make up the mark are comparable with a typical size of condensing water droplets. (5 to 10 microns), the marking shortcomings manifest in terms of low contrast and rapid disappearance of the image after visualization. Thus, the area of applicability of such tags is limited by the above conditions.

The closest to the claimed method is a method of marking diamond by a focused ion beam. According to this method the diamond surface is first polished. A marking image, optically visible in the reflected light (with the help of special optical devices) is produced on the polished surface. The image is formed by modifying the marked part of the surface using a focused ion beam with the energy of ion greater than 10 keV, mostly 30-50 keV, which alters the structure of the surface layer of the base object with the possibility of changing the optical properties of modified sites in relation to the optical properties of untreated sites of the marked surface. First, the polished surface of the diamond is coated with a thin layer of conductive material, such as gold; to remove the charge generated on its surface due the impact of the ion beam. The marking image is formed by continuous scanning of the defined surface sites with the focused ion beam thereby breaking down the bonds between adjacent atoms of the crystal lattice, followed by chemical etching of those sites by, for example, sodium nitride, with partial removal of the basis material, i.e. changing the original topography of the product's polished surface by producing grooves (U.S. Pat. No. 6,391,215).

The following should be listed among the disadvantages of this known prior art method

Due to the fact that the modification is performed by continuous scanning of the product surface sites that will form the marking image with a focused ion beam of high-energy ions, atomic bonds are broken in the crystal lattice of the diamond at these sites. As a result, the base material acquires graphitic structure and, when etching, rough spots develop at these sites, leading to light scattering. However, given the fact that the difference in the refractive indices between diamond and air is relatively low, the grooves that form an image should be deep enough to obtain a perceptible image in reflected light, some 30 nm or deeper. Otherwise, the image will be almost imperceptible in the reflected light.

Damaging the integrity of the polished surface, that is actual presence of micro engraving, will clearly alter the appearance of products, which entails a decline in the value of the product. For this reason, the scope of applicability of this type of marking is sharply reduced.

In addition, occasional need arises to change the marking. In such case, the diamond must be subjected to additional polishing to a depth of the previously formed mark, i.e. 30 nm or more.

The disadvantages of said method should also include the complexity of the technological process of modification. The reason is that a focused ion beam with the necessary (aforementioned) ion energy can be obtained and used only in high vacuum (10⁻⁶ torr). In addition, the method requires the use of labor-intensive and hazardous processes, whereby the layer of gold is first removed with acid and then, using sodium nitride at a temperature of 380-950 degrees Celsius for one hour, material is removed having partially destroyed inter-atomic bonds.

Thus, the above-mentioned shortcomings restrict the use of the known prior art method.

### DISCLOSURE OF INVENTION

The basis of the disclosed invention is the task of expanding the applicability of the method by forming an the identification surface of the product a durable mark, optically visible in reflected light, i.e. visible with an optical microscope clearly, that is with sufficient contrast and spatial resolution, owing to the changes in the optical properties of the identification surface imparted by means of a modifier being such a material, the ion of which would alter the complex refractive index of the base material upon implantation into its crystalline lattice without damaging the polished surface integrity, as well as owing to reduction in the impact of the identification surface contamination on the image contrast, and the enhanced ease of the process implementation.

The stated task is solved by utilization of a method of marking valuable items, whereby the identification surface of the product is first polished; a marking image, optically visible in reflected light is formed on the polished surface by modifying the identification area of said surface by means of a guided ion beam with a given ion energy; in the modification process, the composition of the surface layer is modified with the possibility of changing the optical properties of modified sites in relation to the optical properties of untreated sites of the identification surface, whereby, according to the invention, the modification of the identification surface is carried out by a pulse ion beam through a stencil mask, resulting in implantation of modifier ions into the crystal lattice of the marking area of the surface layer without damaging the covalent bonds between the atoms of the lattice and, accordingly, without damage to the original topography of this layer, and said changes in the optical properties of the marking area are provided through the use as a modifier of such material, the ions of which alter the complex refractive index of the base material upon implantation into its crystal lattice.

It is best to change the complex refractive index of the base material in the direction of increased imaginary component, which characterizes the absorption of incident light and consequently increases the intensity of the reflected light, as it occurs when light is reflected of metal surfaces.

Boron ions or ions of precious metals are useful doping additives or modifiers for marking of diamonds.

It is advisable to perform the implantation of doping additives into the crystal lattice by using modifier ions with energy lees than 10 keV, preferably 5-6 keV.

### THE BEST EMBODIMENT OF THE INVENTION

The disclosed method is performed as follows.

To implement the marking procedure, the identification surface of the product is first polished. A marking image, optically visible in reflected light is formed on the polished surface by modifying the identification area of said surface by means of a guided ion beam with a given ion energy, in the modification process, the composition of the surface layer is modified with the possibility of changing the optical properties of modified sites in relation to the optical properties of untreated sites of the identification surface. The modification of the identification surface is carried out by a pulse ion beam through a stencil mask, resulting in implantation of modifier ions into the crystal lattice of the marking area of the surface layer without damaging the covalent bonds between the atoms of the lattice and, accordingly, without damage to the original topography of the layer. Said changes in the optical properties of the marking area are provided through the use as a modifier of such material, the ions of which alter the complex refractive index of the base material upon implantation into its crystal lattice.

It is best to change the complex refractive index of the base material in the direction of increased imaginary component, which characterizes the absorption of incident light and consequently increases the intensity of the reflected light, i.e. its reflectivity.

Boron ions or ions of precious metals are useful doping additives.

It is advisable to perform the implantation of doping additives into the crystal lattice by using modifier ions with energy less than 10 keV, preferably 5-6 keV.

Thus, implementation of the disclosed method provides a maximum change in the refractive index of material in the modified sites of the marking surface, which actually changes the reflectivity value, primarily increasing it.

For example, when the surface of a diamond is doped with boron ions, the doped sited acquire semiconductor properties. The refractive index of the modifier (doped) sites changes drastically. As a result, when applying a mark in this manner, its image in the reflected light is brighter in relation to the unmodified surface of the article, because the doped areas have much greater reflectivity.

Thus, for very small images, for which the invisible marking (WO 02/089041, C1, EP 1391841) is ineffective, it is advisable to have a mark visible in reflected light, obtained without removing any of the material and without damaging the integrity of the polished surface. This would be a mark obtained by changing the refractive index of the base through doping of the original material on the sites forming the markings image, resulting in a sharp increase in the reflectivity of the doped areas.

Doping will not damage the polished surface nor will it damage the surface topography.

The part of the incident light reflected from the doped sites is visible even with the depth of the modified (doped) layer of material being just a few nanometers. A thin contaminant film that always forms on the surface of the products is optically transparent to the reflected as well as to the incident light and will have little effect on the contrast of the mark obtained in this disclosed manner

The rate of energy supplied by the beam (i.e. absorbed radiation dose divided by time) is important for the disclosed method. In this invention, the dose of radiation absorbed by the base material accumulates gradually (in pulses), which prevents damage to the base surface at the modified sites, owing to the radiation dose in a single pulse not being high enough to break the interatomic covalent bonds in the lattice of the material, such as diamond. The exposure mode is selected empirically. Implementation of the disclosed method does not require high vacuum, because irradiation is performed with an unfocused ion beam with 10 keV ion energy in the pulse mode. This, and the absence of chemical etching enhance the ease of application. The ion energy determines the depth of the modified layer of a few nanometers, sufficient for the long-term, almost permanent, use of a mark on the surface of a diamond. In some cases, the marking image may need to be modified, for example, with change in the ownership of the article. According to the disclosure, the mark can penetrate to a depth from several nanometers to 10 nm without upsetting the topography of the surface layer; therefore, it is easily removed by polishing, if necessary.

The mark is durable because the modification of the article's surface leading to changes in its refractive index, obtained, for example, by spatially modulated pulsed metal ion beam, leads to a permanent change in the composition and structure of the surface with a modified refractive index.

An example of a specific implementation of the disclosed method.

A marking image in the form of letters and numbers, hidden to the naked eye but optically visible in reflected light by using a microscope, was formed on the polished surface of a diamond sample by modifying the surface of the specimen by means of an ion beam (boron ions) through a stencil mask. Tests carried out on the original marking within one year did not reveal any reduction in contrast of the mark. The marking is also resistant to mechanical abrasion and the action of acids and other chemicals (solvents).

### INDUSTRIAL APPLICABILITY

Thus, the Invention may find wide use in various fields of science and technology for recording and reading identity information; in particular, it can be used for marking of diamonds smaller than 0.3 carats.

1. A method for marking valuable articles, whereby the identification surface of the product is first polished: a marking image, optically visible in reflected light is formed on the polished surface by modifying the identification area of said surface by means of a guided ion beam with a given ion energy: in the modification process, the composition of the surface layer is modified with the possibility of changing the optical properties of modified sites in relation to the optical properties of untreated sites of the identification surface, characterized by the modification of the identification surface being carried out by a pulse ion beam through a stencil mask, resulting in implantation of modifier ions into the crystal lattice of the marking area of the surface layer without damaging the covalent bonds between the atoms of the lattice and, accordingly, without damage to the original topography of this layer, and said changes in the optical properties of the marking area being provided through the use as a modifier of such material, the ions of which alter the complex refractive index of the base material upon implantation into its crystal lattice as doping additives.

2. The method of claim 1, wherein the complex refractive index of the base material is modified to obtain an increase in its imaginary component, which characterizes the absorption of incident light and consequently increases the intensity of the reflected light.

3. The method of claim 1, wherein boron or precious metal ions are used as the doping additives.

4. The method of claim 1, wherein the doping additives are implanted into the crystal lattice by using modifier ions with energy less than 10 keV, preferably 5-6 keV.
